(19) United States
(12) Patent Application Publication
(10) Pub. No.: US 2008/0141830 A1
(43) Pub. Date: Jun. 19, 2008

(54) Cork Extractor

(76) Inventor: Claude Mauffette, Montreal (CA)

Correspondence Address: ANDREWS & KURTH, L.L.P., 600 TRAVIS, SUITE 4200, HOUSTON, TX, 77002, US

(21) Appl. No.: 11/815,854

(22) PCT Filed: Dec. 21, 2005
(86) PCT No.: PCT/IB05/03991

§ 371 Date: Nov. 7, 2007

(30) Foreign Application Priority Data
Feb. 8, 2005 (GB) 0502568.9

(51) Int. Cl. B67B 7/04; B67B 7/44; B67B 7/18

(52) U.S. Cl. 81/3.08; 81/3.29; 81/3.45

(57) ABSTRACT

Apparatus (2, 22) for extracting a cork (14) from a bottle (8) containing gaseous liquid comprising cork-engaging means (12, 28) having a cork engaging passageway extending generally longitudinally therethrough for engaging the cork (14), trap means (6) for trapping the expelled cork and bottle-engaging means (4) connected to the cork-engaging means and the trap means for positioning the cork-engaging means and trap means with respect to the neck of the bottle such that the cork-engaging means engages the cork and the trap means is located for trapping the expelled cork, wherein the cork-engaging means (12, 28) includes cork-gripping means (16, 32) provided on the cork-engaging passageway which is operative to prevent rotation of the cork on rotation of the bottle with respect to the bottle-engaging means (12, 28) and wherein the trap means (6) arrests the flight of the cork after it is expelled from the bottle.

This invention relates to apparatus for extracting corks from bottles, in particular for extracting corks from bottles containing gaseous liquids, especially sparkling wines.

Bottles for sparkling wines such as champagne usually have an elongate neck with a top spout area surrounding the bottle mouth and a circumferential rib therebelow which provides for anchorage of a cage of wire that holds the cork in the bottle against the pressure generated on the bottom face of the cork by the gas from the wine.

The difficulty of removing a cork from a champagne bottle as well as the difficult of controlling the cork once it exits from the bottle are both well known. The high pressure occurring in bottles of champagne and other sparkling wines means that removing the cork may be an intimidating, and even hazardous, task.

A number of devices have been proposed for removing the cork from bottles of gaseous liquids. The classic approach is to provide a device which produces a vertical lifting force on the cork. However, due to the high static friction between the cork and the interior neck of the bottle which is required to prevent the cork from leaving the bottle immediately the cage of wire is disconnected, such lifting devices may require a great deal of force.

A cork remover which is intended to avoid the need to apply an external lifting force is disclosed in U.S. Pat. No. 4,800,783. The device comprises a single body which can be considered as being formed from a pair of inverted U-shaped members which provide four edges for engagement with the cork. The device is then rotated and the internal pressure within the bottle overcomes the sliding friction between the cork and the bottle, thus causing the cork to be expelled.

The device takes advantage of the fact that the static friction between the sides of the cork and the interior neck of the bottle is much greater than the sliding friction between those same surfaces. By applying a rotary motion to the cork with no external lifting force, the internal pressure within the bottle overcomes the sliding friction between the cork and bottle surfaces and the cork is expelled. The rotary action needed to establish sliding friction is quite easy to apply compared to a pulling action.

However, the device of U.S. Pat. No. 4,800,783 suffers from the disadvantage that the cork can still exit the bottle at considerable speeds and so removing the cork can remain intimidating or even hazardous. Furthermore, it has been found that, in practice, a lifting force may still need to be applied to achieve cork expulsion.

The present invention provides apparatus for extracting a cork from a bottle with which the cork is engaged such that a portion of the cork is exposed above the bottle neck, the apparatus comprising cork-engaging means having a cork-engaging passageway extending generally longitudinally therethrough, trap means for trapping the expelled cork and bottle-engaging means connected to the cork-engaging means and the trap means for positioning the cork-engaging means and the trap means with respect to the neck of the bottle such that the cork-engaging passageway engages the exposed cork portion and the trap means is located for trapping the expelled cork, wherein the cork-engaging means includes cork-gripping means provided on the cork-engaging passageway which is operative to prevent rotation of the cork on relative rotation of the bottle and the bottle-engaging means and wherein the trap means arrests the flight of the cork after it is expelled from the bottle.

The provision of trap means for arresting the flight of the cork has the advantage that expulsion of the cork is controlled. The bottle-engaging means cause proper location of the cork-engaging means and the trap means with respect to the cork and also provides a structure which can be gripped at a distance from the cork which is reassuring for the user.

In a preferred embodiment the bottle-engaging means comprises at least two longitudinally extending circumferentially spaced holder legs defining between them a space in which the bottleneck is received. The holder legs may be connected at least at their lower extremities. They may form part of a cylindrical tube.

The apparatus preferably comprises stop means, suitably in the form of a flange, for locating the bottle-engaging means with respect to the bottle such that, on further relative rotation of the bottle and the bottle-engaging means, the cork-gripping means exerts a force on the exposed cork portion in a direction to draw the cork from the bottle.

A particularly preferred form for the cork-gripping means is as male screw threads.

The trap means may comprise a trap member defining a cork receiving space. The cork receiving space preferably decreases in a cross sectional area in the direction of cork flight.

In one embodiment the trap member may comprise an open sided tube of conical cross section.

In another embodiment the trap member comprises two side members and an end member defining between them the cork receiving space, the end member extending generally across to the bottle mouth but spaced therefrom by the side members.

The cork-engaging member, trap member and bottle-engaging member are very preferably either integral or permanently connected whereby the apparatus is unitary.

The cork extractor, at least in the preferred embodiments, provides for safe controlled cork removal without applying a lifting force. It has neither movable nor complex parts and instead has a unitary form.

The invention will now be further described by way of example with reference to the accompanying drawings in which:

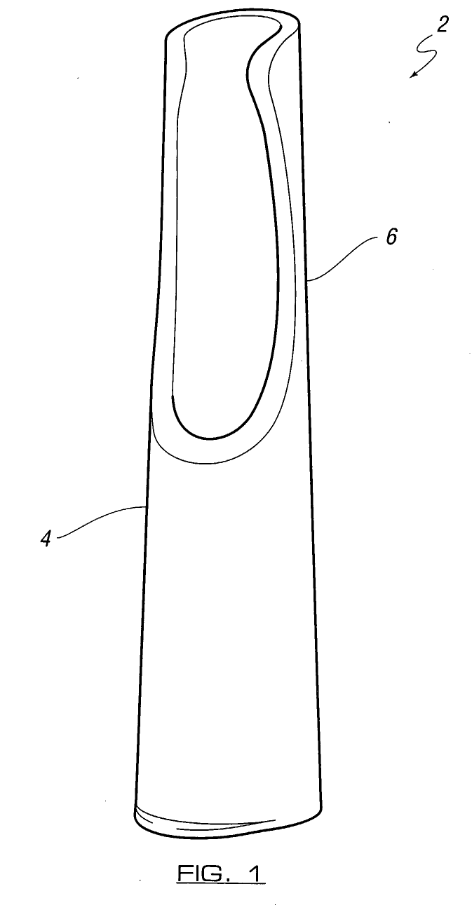

FIG. 1 is a perspective front view of a cork extractor in accordance with one embodiment of the present invention;

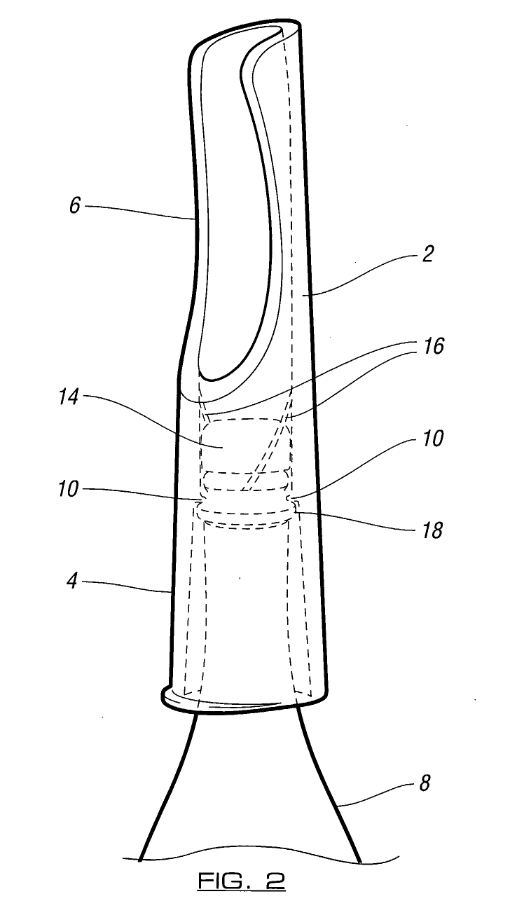

FIG. 2 is a partial cut through view of the cork extractor of FIG. 1 positioned on top of a bottle;

FIG. 3 is a further partial cut through view of the cork extractor of FIG. 1 illustrating the situation when the cork has been expelled from the bottle;

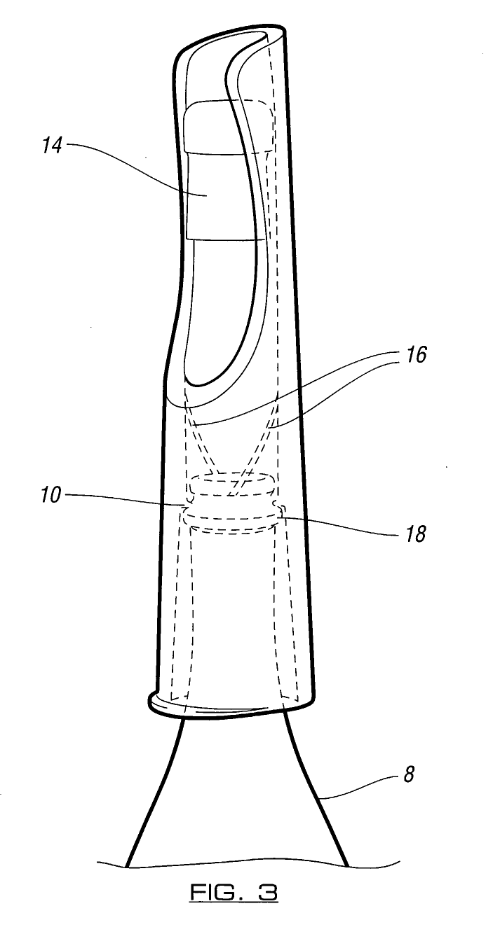

FIG. 4 is a perspective front view of another embodiment of a cork extractor in accordance with the invention;

FIG. 5 is a perspective view of cork-engaging means of the cork extractor of FIG. 4 with the parts thereof separated;

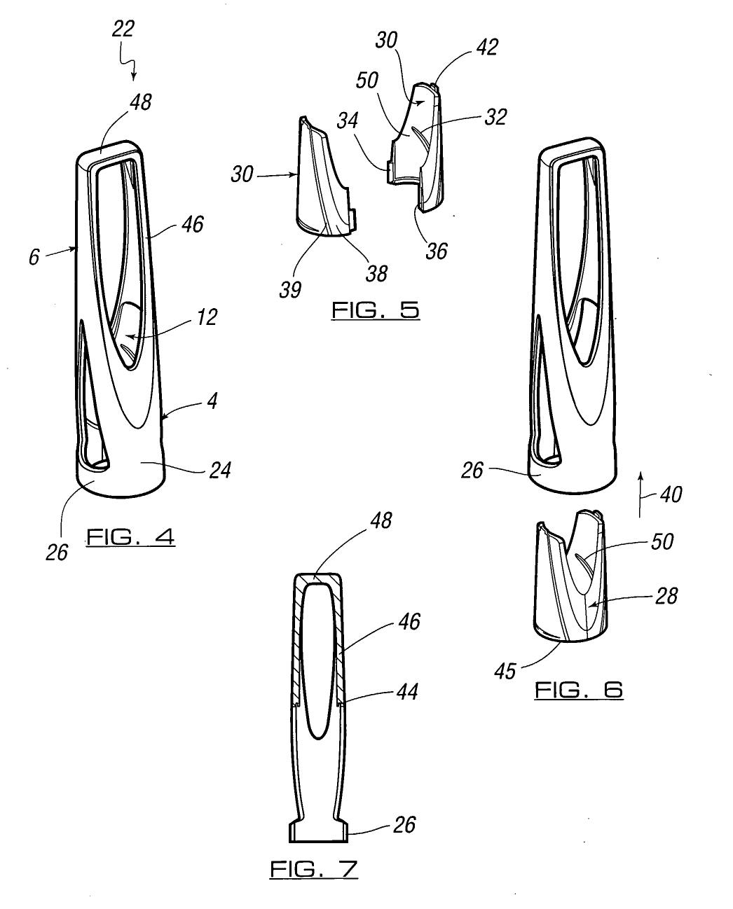

FIG. 6 is a perspective view illustrating assembly of the parts of the cork-engaging means of FIG. 4, and,

FIG. 7 is a vertical section through bottle-engaging means and trap means of the cork extractor of FIG. 4, and,

The cork extractor 2 shown in FIGS. 1 to 3 comprises a bottle-engaging portion 4 and a trap portion 6.

The bottle-engaging portion 4 is essentially a cylindrical tube of dimensions to engage the neck of bottle 8 as illustrated in FIGS. 2 and 3. As shown in those Figures, the bottle-engaging portion 4 has an inner circumferential flange 10.

The portion 12 of the device 2 between the bottle-engaging portion 4 and the trap portion 6 defines a passageway dimensioned to receive a cork 14. The passageway has cork-gripping means 16 which in the illustrated embodiment comprises male screw threads.

To remove cork 14 from bottle 8, the cork extractor 2 is first positioned on top of the bottle 8 so that the bottle-engaging portion 4 surrounds the cork 14. The cork extractor 2 is moved downwardly in the sense of the Figures to locate the bottle-engaging portion 4 around the neck of the bottle 8 and the cork-engaging portion 12 around the cork 14. This brings the lower extremity of the cork-gripping means 16 into contact with the top edge of the cork.

One of the bottle 8 and cork extractor 2 is then rotated relative the other so that the cork-gripping means 16 fully engage with the side of the cork 14 until the downward movement is stopped by the inner circumferential flange 10 of the bottle-engaging portion 4 reaching the circumferential anchorage rib 18 provided on the neck of the bottle 8. Continued relative rotation causes the cork-gripping means 16 to exert an upward action on the cork 14. The cork 14 is thus lifted upwardly until it is finally expelled from the bottle 8 under the action of the pressure inside the bottle 8.

As illustrated in FIGS. 2 and 3, the trap portion 6 has an open conical shape which serves to trap the expelled cork whilst allowing lateral removal thereof once its flight has been stopped.

The cork-gripping means 16 may take other forms such as ribs or tongues provided that there is sufficiently secure engagement with the cork but no interference with expulsion of the cork. The illustrated male screw threads are particularly preferred and it has been found that at least one male screw thread having an orientation between about 15° and 90° in relation to a horizontal plane is effective, with 40° to 90° being preferred.

The cork extractor 2 provides for effective and safe removal of corks from bottles containing gaseous liquids whilst being of one part construction.

Turning now to FIGS. 4 to 7, these illustrate a second embodiment of a cork extractor 22 which has a number of features in common with cork extractor 2 and so like reference numerals will be used for like parts.

The cork extractor 22 comprises a bottle-engaging portion 4 and a trap portion 6 with a cork-engaging portion 12 therebetween. The bottle-engaging portion can be considered as having two holder legs 24 which are joined at their lower ends to form a neck encircling ring 26. The neck encircling ring 26 ensures proper location of the cork-engaging portion 12 and the trap portion 6 with respect to the bottle 8 and cork 14, whilst the leg members 24 still provide for firm gripping of the cork extractor 22.

In this embodiment the cork-engaging means is provided as a two-part cork-engaging member 28 which is separately formed from, but then permanently connected to, the remainder of the cork extractor 22. This has been found to facilitate production of the cork extractor 22.

As illustrated in FIG. 5, the cork-engaging member 28 is formed from two mirror image parts 30 each having cork-gripping means in the form of a male thread 32. The parts 30 are connected by engaging a lug 34 on one with a socket 36 in the other. The assembled cork-engaging member 28 has four glue receiving faces 38 on its exterior surface. After application of glue to the faces 38, the cork-engaging member 28 is inserted through the neck encircling ring 26 as illustrated by arrow 40 in FIG. 6 until tabs 42 on its upper edges engage recesses 44 provided below the trap portion 6, see FIG. 7. Excess glue squeezed out will be received in channels 39 provided adjacent the faces 38 and so will not be visible on the final product. On setting of the glue the cork extractor 22 is rendered of unitary construction.

The cork extractor 22 is operated in a generally similar fashion to the cork extractor 2. It is placed on a bottle and firmly held with one hand. The other hand is used to grip the bottle. One of the bottle and the cork extractor 22 is then rotated relative the other. The cork-gripping means 32 is thereby engaged with the cork to cause this to be expelled from the bottle. In this embodiment the lower face 45 of the cork-engaging member 28 acts as the flange for engaging the circumferential anchorage rib 18.

The expelled cork is received in the trap portion 6 which in this embodiment comprises two side members 46 and an end member 48 which extends therebetween. The expelled cork is trapped between the inner surfaces of the side members 46, which inside surfaces have an angled draft to prevent the cork from falling downwardly. The side members 46 are dimensioned to trap the smallest cork in commercial use but even if they fail to do the flight of the cork will be arrested by the end member 48. The cork is removed from the extractor 22 by pushing it out from between the side members 46.

Like the first embodiment, the second embodiment provides for safe and effective removal of a cork from a bottle containing a gaseous liquid. Again, it has no movable parts. However, manufacturer is facilitated in comparison with the first embodiment by making it of unitary rather than integral construction.

Although described as particularly suitable for removal of a cork from a bottle containing a gaseous liquid, the cork extractor 2, 22 is effective even if there is no gaseous pressure on the cork.

It has been found that cork extraction is facilitated, especially with smaller corks, if the male threads or blades 16, 32 are provided with small protrusions 50 near both ends as illustrated in FIGS. 5 and 6.

The cork extractor 2, 22 is suitably made from plastic material.

1. Apparatus (2, 22) for extracting a cork (14) from a bottle (8) containing gaseous liquid comprising cork-engaging means (12, 28) having a cork engaging passageway extending generally longitudinally therethrough for engaging the cork (14), trap means (6) for trapping the expelled cork (14) and bottle-engaging means (4) connected to the cork-engaging means (12, 28) and the trap means (6) for positioning the cork-engaging means (12, 28) and trap means (6) with respect to the neck of the bottle such that the cork-engaging means (12, 28) engages the cork (14) and the trap means (6) is located for trapping the expelled cork (4), wherein the cork-engaging means (12, 28) includes cork-gripping means (16, 32) provided on the cork-engaging passageway which is operative to prevent rotation of the cork (14) on rotation of the bottle (8) with respect to the bottle-engaging means (12, 28) and wherein the trap means (6) arrests the flight of the cork (14) after it is expelled from the bottle (8).

2. Apparatus as claimed in claim 1 wherein the bottle-engaging means comprises at least two longitudinally extending circumferentially spaced holder legs (24) defining between them a space in which the bottle neck is received.

3. Apparatus as claimed in claim 2 wherein the holder legs (24) are connected at least at their lower extremities.

4. Apparatus as claimed in either claim 2 or claim 3 wherein the holder legs form part of a cylindrical tube.

5. Apparatus as claimed in any preceding claim wherein the bottle-engaging means includes stop means (10, 45) for engaging the bottle to limit movement of the bottle-engaging means (4) with respect to the bottle, such that, on further relative rotation of the bottle and the bottle-engaging means, the cork-gripping means (16, 32) exert a force on the exposed cork portion in a direction to draw the cork from the bottle.

6. Apparatus as claimed in claim 5 wherein the stop means comprises a flange (10).

7. Apparatus as claimed in any preceding claim wherein the cork-gripping means comprises male screw threads (16, 32).

8. Apparatus as claimed in claim 7 wherein the screw threads (16, 32) are formed with a protrusion (50) adjacent each end.

9. Apparatus as claimed in any preceding claim wherein the trap means (6) comprises a trap member defining a cork receiving space.

10. Apparatus as claimed in claim 9 wherein the cork receiving space decreases in cross-sectional area in the direction of cork flight.

11. Apparatus as claimed in claim 10 wherein the trap member comprises an open sided tube of conical cross-section.

12. Apparatus as claimed in claim 9 wherein the trap member comprises two side members (46) and an end member (48) defining between them the cork receiving space, the end member (48) extending generally across the bottle mouth but spaced therefrom by the side members (46).

13. Apparatus as claimed in any one of claims 1 to 11 wherein the cork-engaging means (12), trap means (6) and bottle-engaging means (4) are integral.

14. Apparatus as claimed in any one of claims 1 to 10, 12 and 13 wherein the cork-engaging means (28), trap means (6) and bottle-engaging means (4) are permanently connected whereby the apparatus is unitary.
